(19) United States
(12) Patent Application Publication
(10) Pub. No.: US 2012/0262391 A1
(43) Pub. Date: Oct. 18, 2012

(54) TOUCH SCREEN DEVICE AND PLASMA DISPLAY APPARATUS HAVING THE SAME

(75) Inventors: Tadashi MAKI, Fukuoka (JP); Taichi YAMADA, Fukuoka (JP); Takashi KITADA, Fukuoka (JP)

(73) Assignee: PANASONIC CORPORATION, Osaka (JP)

(21) Appl. No.: 13/434,054

(22) Filed: Mar. 29, 2012

(30) Foreign Application Priority Data
Apr. 15, 2011 (JP) 2011-090985

(51) Int. Cl. G06F 3/041; G09G 3/28

(52) U.S. Cl. 345/173; 345/60

(57) ABSTRACT

A touch screen device includes a screen main body comprising a plurality of transmitting electrodes and a plurality of receiving electrodes and disposed in front of a plasma display panel; a transmitter sequentially selecting the transmitting electrodes and applying a drive signal to the selected transmitting electrodes; a receiver sequentially selecting the receiving electrodes, receiving a response signal output from each of the receiving electrodes in response to the drive signal, and outputting detection data at each electrode intersection; a discharge detector detecting discharge of each of the scanning electrodes of the plasma display panel; and a controller that obtains a touch position based on detection data of the discharge detector at each electrode intersection acquired from the response signals from the receiving electrodes positioned distant from the discharging scanning electrodes.

### CROSS-REFERENCE TO RELATED APPLICATIONS

The present application claims priority under 35 U.S.C. §119 of Japanese Application No. 2011-090985 filed on Apr. 15, 2011, the disclosure of which is expressly incorporated by reference herein in its entirety.

### BACKGROUND OF THE INVENTION

1. Field of the Invention

The present invention relates to a touch screen device disposed in front of a plasma display panel and a plasma display apparatus having the touch screen device.

2. Description of Related Art

There are various methods utilizing different principles for a touch screen device to detect a touch position. In a configuration where numerous electrodes are provided in a panel, such as resistive and capacitance types, the electrodes act as antennas, and are thus susceptible to exogenous (external) noise. In the capacitance type, in particular, a touch position is detected from a minor variation in capacitance proximate to electrodes caused by approaching or contacting of a conductive object (e.g., human body). Thus, noise substantially affects accuracy of detecting a touch position.

A touch screen device is generally used in combination with an image display apparatus, such as a liquid display panel. Integrating an image display apparatus with a touch screen device reduces the accuracy of detecting a touch position due to noise caused by the image display apparatus. A technology is known to reduce an impact of such noise attributed to the image display apparatus (Related Arts 1 and 2).

A plasma display panel is considered as such an image display apparatus used in combination with the touch screen device. Due to substantial radiated noise associated with discharge, however, the conventional noise reducing method does not sufficiently solve the noise issue and substantially reduces the accuracy of detecting a touch position, and is thus incapable of ensuring sufficient detection accuracy in practice.
[Related Art 1] Japanese Patent Laid-open Publication No. S63-174120
[Related Art 2] Japanese Patent Laid-open Publication No. 2010-009439

### SUMMARY OF THE INVENTION

In view of the circumstances above, a main advantage of the present invention is to provide a touch screen device and a plasma display apparatus having the same, the touch screen device being configured to prevent a reduction in detection accuracy of a touch position affected by radiated noise from a plasma display panel used in combination therewith.

A touch screen device of the present invention includes a screen main body comprising a plurality of transmitting electrodes and a plurality of receiving electrodes and disposed in front of a plasma display panel, the transmitting electrodes being provided parallel to one another, the receiving electrodes being provided parallel to one another, the transmitting electrodes and the receiving electrodes being disposed in a grid shape, the receiving electrodes being disposed parallel to scanning electrodes of the plasma display panel; a transmitter sequentially selecting the transmitting electrodes and applying a drive signal to the selected transmitting electrodes; a receiver sequentially selecting the receiving electrodes, receiving a response signal output from each of the receiving electrodes in response to the drive signal, and outputting detection data at each electrode intersection; a discharge detector detecting discharge of each of the scanning electrodes of the plasma display panel; and a controller that obtains a touch position based on detection data of the discharge detector at each electrode intersection acquired from the response signals from the receiving electrodes positioned distant from the discharging scanning electrodes.

According to the present invention, the receiving electrodes and the scanning electrodes are parallel to each other, and thus radiated noise is unlikely to mix into the receiving electrodes distant from the scanning electrodes that are discharging. A reduction in detection accuracy of a touch position due to the radiated noise of the plasma display panel can surely be prevented.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an overall configuration of a plasma display apparatus according to an embodiment;

FIG. 2 illustrates a schematic configuration of a reception signal processor;

FIGS. 3A to 3C each schematically illustrate discharge control of a PDP;

FIGS. 4A and 4B are each a waveform diagram illustrating radiated noise of the PDP;

FIGS. 5A and 5B each schematically illustrate a placement of transmitting electrodes and receiving electrodes of a touch screen device and scanning electrodes and address electrodes of the PDP;

FIG. 6 schematically illustrates a configuration of a main portion that detects discharge of the PDP in the touch screen device;

FIG. 7 schematically illustrates a state of scanning during an address discharge period;

FIG. 8 is a flowchart illustrating a procedure of processing performed in a controller of the touch screen device;

FIG. 9 schematically illustrates a state of discharge in the PDP and scanning in the touch screen device;

FIG. 10 is a flowchart illustrating a procedure of processing performed in the controller of the touch screen device;

FIG. 11 is a flowchart illustrating a procedure of processing performed in the controller of the touch screen device; and

FIG. 12 is a plan view illustrating the transmitting electrodes and the receiving electrodes.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

An embodiment of the present invention is explained below with reference to the drawings.

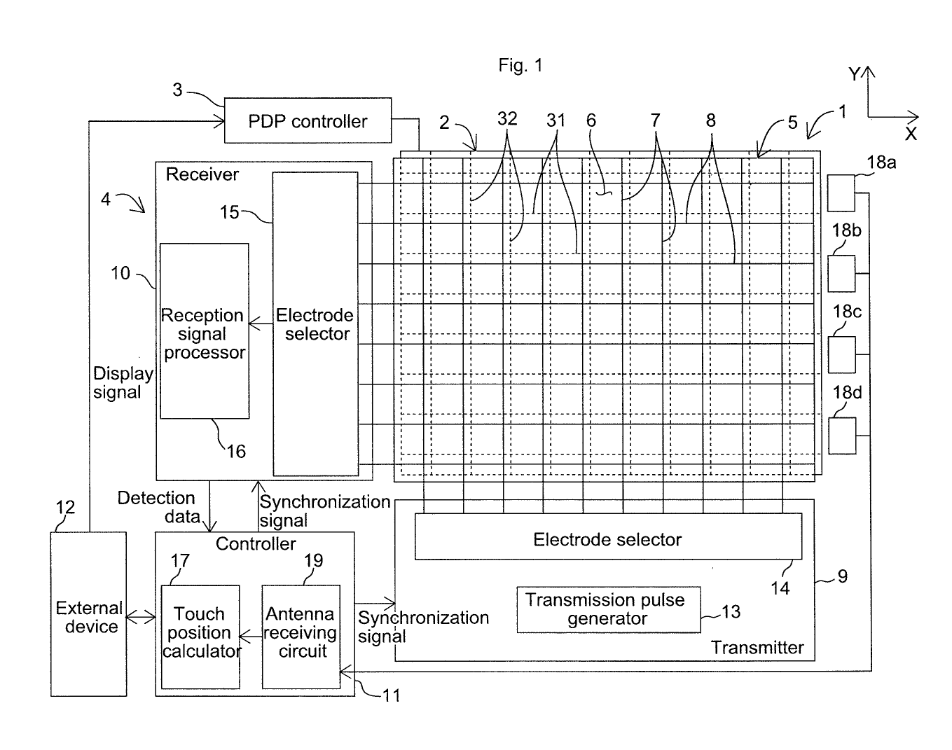

FIG. 1 illustrates an overall configuration of a plasma display apparatus 1 according to the present embodiment. The plasma display apparatus 1 has a plasma display panel (hereinafter referred to as PDP) 2, a PDP controller 3, and a touch screen device 4. A screen main body 5 of the touch screen device 4 is disposed in front of a display surface of the PDP 2.

The screen main body 5 of the touch screen device 4 has a touch surface 6 on which a touch operation is performed with a pointing object (conductive body, such as a user's fingertip, a stylus, or a pointer). A plurality of parallel transmitting electrodes 7 and a plurality of parallel receiving electrodes 8 are disposed in a grid shape.

The touch screen device 4 also includes a transmitter 9, a receiver 10, and a controller 11, the transmitter 9 applying drive signals to the transmitting electrodes 7, the receiver 10 receiving response signals from the receiving electrodes 8 that have responded to the drive signals applied by the transmitting electrodes 7 and outputting detection data at each of electrode intersections where the transmitting electrodes 7 and the receiving electrodes 8 intersect, the controller 11 detecting a touch position based on the detection data output from the receiver 10 and controlling operations of the transmitter 9 and the receiver 10.

The touch position information output from the controller 11 is supplied to an external device 12, such as a personal computer, which generates and outputs display screen data to the PDP controller 3 that controls the PDP 2. Thus, the PDP 2 displays on the screen an image corresponding to a touch operation performed by a user with a pointing object on the touch surface 6 of the screen main body 5, allowing display of a predetermined image in a manner similar to directly drawing on the touch surface 6 with a marker, and operation of buttons displayed on the display screen of the PDP 2. An eraser is also available to delete an image drawn with a touch operation.

The transmitting electrodes 7 and the receiving electrodes 8 intersect in a stacked state with an insulating layer therebetween. A capacitor is formed in an electrode intersection where the transmitting electrode 7 and the receiving electrode 7 intersect. A pointing object, such as a finger, approaches or contacts the touch surface 6 as a user performs a touch operation with the pointing object. Then, the capacitance at the electrode intersection is substantially reduced, thus allowing detection of the touch operation.

A mutual capacitance system is employed herein. Drive signals are applied to the transmitting electrodes 7, and then charge-discharge currents flow to the receiving electrodes 8 in response. The charge-discharge currents are output from the receiving electrodes 8 as response signals. A variation in the capacitance at the electrode intersections at this time in response to a user's touch operation varies the charge-discharge currents of the receiving electrodes 8, specifically, the response signals. The touch position is calculated based on the variation amount. In this mutual capacitance system, detection data obtained from signal processing of the response signals in the receiver 10 is output for every electrode intersection of the transmitting electrode 7 and the receiving electrode 8, thus enabling commonly-called multi-touch (multiple point detection), which simultaneously detects a plurality of touch positions.

A touch position calculator 17 of the controller 11 calculates a touch position (center coordinate of a touch area) based on predetermined calculation of detection data at every electrode intersection output from the receiver 10. In this touch position calculation, a touch position is calculated in a predetermined interpolating method (e.g., centroid method) from detection data of each of a plurality of adjacent electrode intersections (e.g., 4×4) in the X direction (array direction of the transmitting electrodes 7, specifically, the width direction of the PDP 2) and the Y direction (array direction of the receiving electrodes 8, specifically, the height direction of the PDP 2). Thereby, the touch position can be detected at a higher resolution (e.g., 1 mm or less) than the placement pitch (e.g., 10 mm) of the transmitting electrodes 7 and the receiving electrodes 8.

The touch position calculator 17 of the controller 11 also calculates a touch position every frame period in which reception of detection data of every electrode intersection is completed across the touch surface 6 and outputs the touch position information to the external device 12 in a unit of frame. Based on the touch position information of a plurality of temporally continuing frames, the external device 12 generates and outputs display screen data connecting touch positions in time series to the PDP controller 3. In a case of multi-touch, the touch position information including touch positions by a plurality of pointing objects is output in a unit of frame.

The transmitter 9 has a transmission pulse generator 13 generating pulses to serve as drive signals and an electrode selector 14 selecting the transmitting electrodes 7 one by one and sequentially applying the pulses output from the transmission pulse generator 13 to the transmitting electrodes 7.

The receiver 10 has a reception signal processor 16 processing response signals output from the receiving electrodes 8 and an electrode selector 15 selecting the receiving electrodes 8 one by one and sequentially supplying the response signals from the receiving electrodes 8 to the reception signal processor 16.

The transmitter 9 and the receiver 10 operate in response to synchronization signals output from the controller 11. During a time when the transmitter 9 applies a drive signal to one transmitting electrode 7, the receiver 10 selects the receiving electrodes 8 one by one and sequentially supplies response signals from the receiving electrodes 8 to the reception signal processor 16 for signal processing. Sequentially repeating this scanning of one line for all transmitting electrodes 7 provides detection data of every electrode intersection.

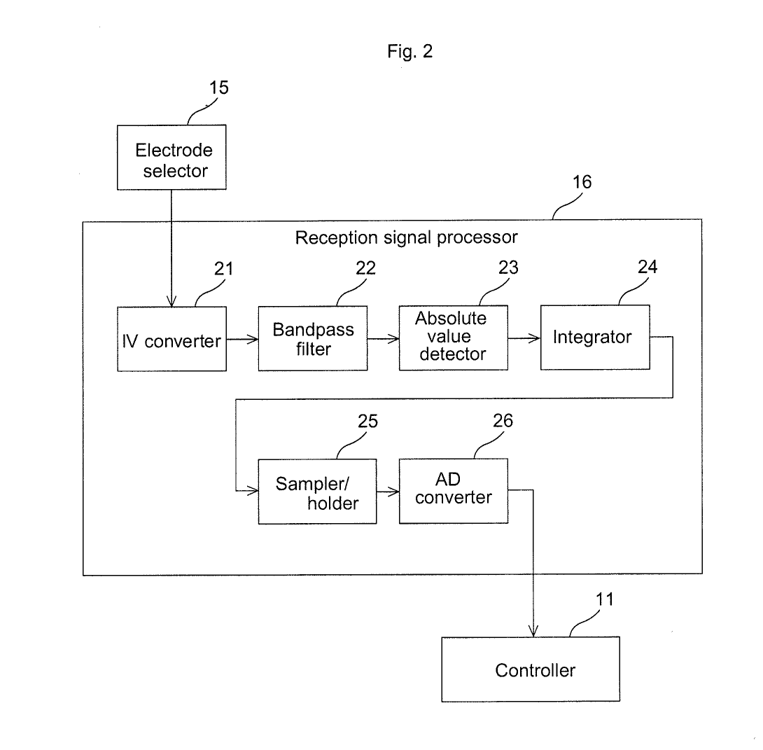

FIG. 2 illustrates a schematic configuration of the reception signal processor 16. The reception signal processor 16 has an IV converter 21, a bandpass filter 22, an absolute value detector 23, an integrator 24, a sampler/holder 25, and an AD converter 26.

The IV converter 21 converts into voltage signals, response signals (charge-discharge current signals) of the receiving electrodes 8 input through the electrode selector 15. The bandpass filter 22 removes from the output signals from the IV converter 21, signals having a frequency component other than a frequency of drive signals applied to the transmitting electrodes 7. The absolute value detector (rectifier) 23 performs full-wave rectification of the output signals from the bandpass filter 22. The integrator 24 integrates the output signals from the absolute value detector 23 in a time axis direction. The sampler/holder 25 samples the output signals from the integrator 24 at a predetermined timing. The AD converter 26 converts the output signals from the sampler/holder 25 from analog to digital and outputs the detection data (level signals) at every electrode intersection.

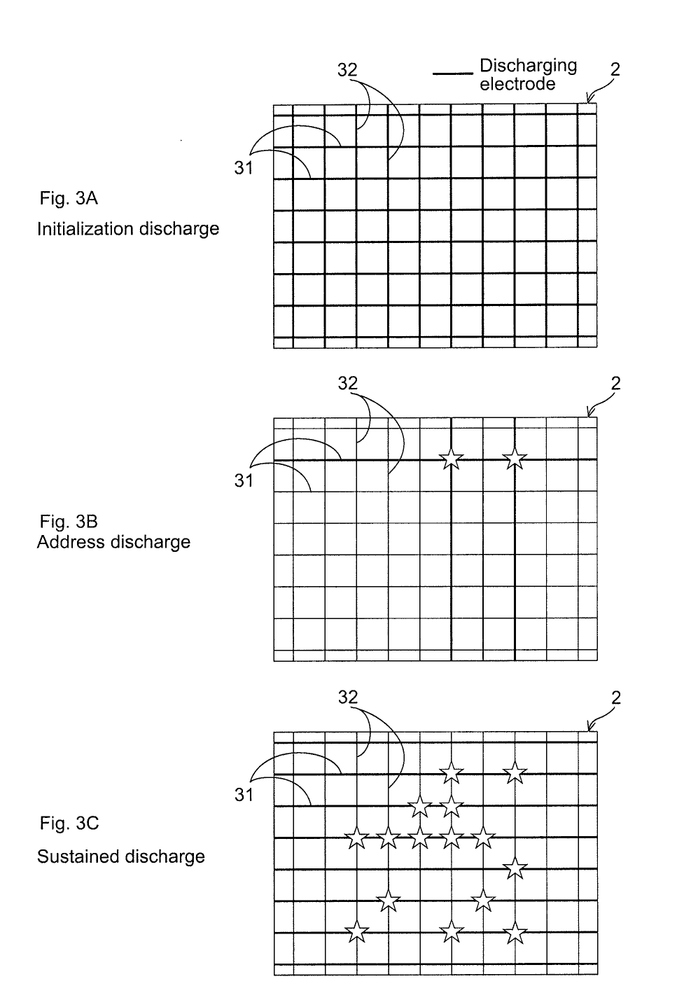

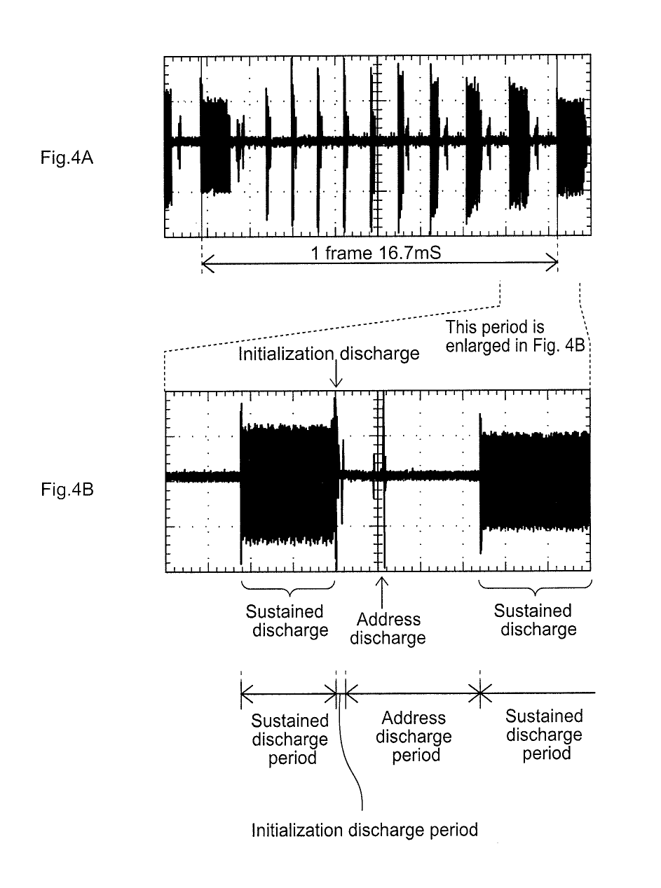

FIGS. 3A to 3C each schematically illustrate discharge control of the PDP 2. FIGS. 4A and 4B are each a waveform diagram illustrating radiated noise of the PDP 2. FIG. 4B is an enlarged view of a main portion of FIG. 4A.

With reference to FIGS. 3A to 3C, the PDP 2 has scanning electrodes 31 and address electrodes 32, which are disposed orthogonal to each other. The scanning electrodes 31 supply a predetermined potential to charge cells formed at intersections of the scanning electrodes 31 and the address electrodes 32 to emit light from the cells. The address electrodes 32 select the charge cells for light emission to control light emission positions.

The PDP 2 is driven in an ADS (Address and Display period Separated) sub-field method, in which one frame (16.7 mS) is divided into a plurality of sub-fields (10 in the example of FIGS. 4A and 4B) on the time axis. Initialization discharge, address discharge, and sustained discharge are sequentially repeated in each sub-field to display multi-tone images.

In the initialization discharge illustrated in FIG. 3A, all the scanning electrodes 31 simultaneously discharge. In the address discharge illustrated in FIG. 3B, the scanning electrodes 31 are selected one by one to discharge. In the sustained discharge illustrated in FIG. 3C, all the scanning electrodes 31 simultaneously discharge again. The sustained discharge allows selected charge cells to emit light, the cells being selected based on combinations of the scanning electrodes 31 and the address electrodes during the address discharge. Performing the initialization discharge, the address discharge, and the sustained discharge for one time (i.e., once) displays an image for one tone in one frame.

In the PDP 2 that operates as above, high-level radiated noise is constantly generated during the sustained discharge and is also generated in the initialization discharge, as shown in FIGS. 4A and 4B. During the address discharge, however, the scanning electrodes 31 are selected one by one from top to bottom of the screen to discharge. The radiated noise is thus generated only from the selected scanning electrodes 31. The timing of radiated noise generation is different depending on the positions of the scanning electrodes 31, and thus high-level radiated noise is not mixed into the receiving electrodes 8 that are distant from the discharging scanning electrodes 31.

As described above, the radiated noise is generated during any period of the initialization discharge, address discharge, and sustained discharge. Performing scanning in the touch screen device 4 at the same timing of or during generation of the radiated noise causes misdetection of a touch position due to the radiated noise. In the present embodiment, scanning is performed while avoiding the timing of generation of the radiated noise as described below. Specifically, scanning is performed targeting the receiving electrodes 8 distant from the scanning electrodes 31 that discharge during the address discharge period.

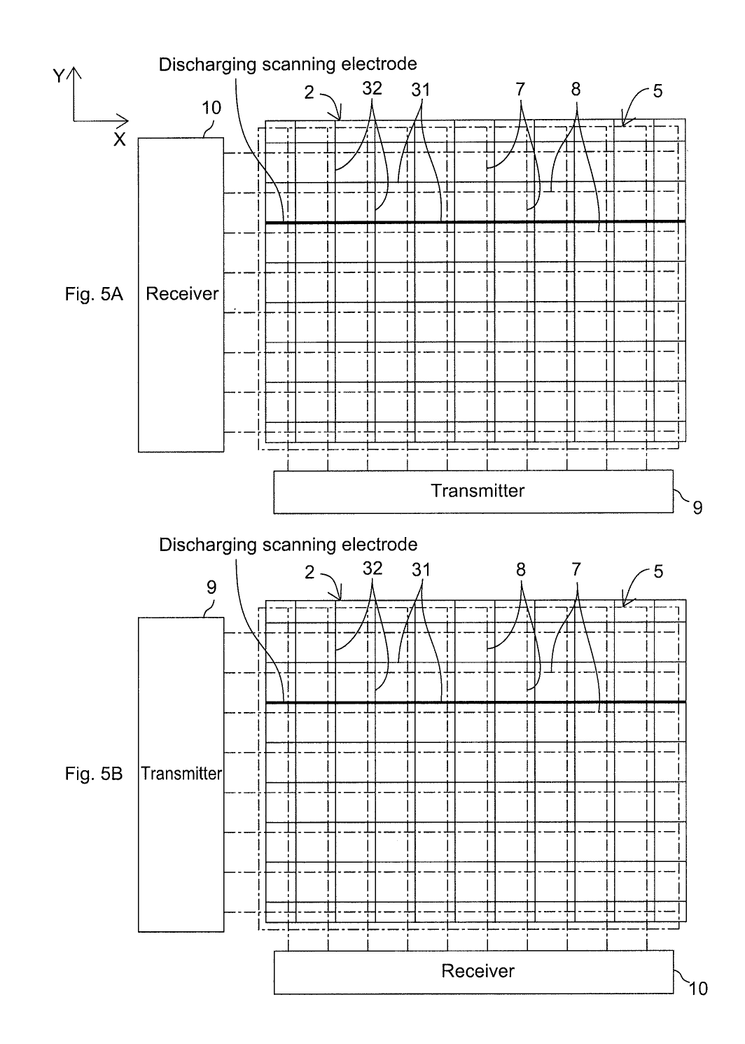

FIGS. 5A and 5B each schematically illustrate a placement of the transmitting electrodes 7 and the receiving electrodes 8 of the touch screen device 4 and the scanning electrodes 31 and the address electrodes 32 of the PDP 2. FIG. 5A illustrates the present embodiment, while FIG. 5B illustrates a comparative example.

With reference to FIG. 5A, in the present embodiment, the transmitting electrodes 7 extend in the Y direction and the receiving electrodes 8 extend in the X direction in the screen main body 5 of the touch screen device 4, while the scanning electrodes 31 extend in the X direction and the address electrodes 32 extend in the Y direction in the PDP 2. The receiving electrodes 8 of the touch screen device 4 and the scanning electrodes 31 of the PDP 2 are disposed in parallel to each other.

Thus, the receiving electrodes 8 proximate to the discharging scanning electrodes 31 are affected by radiated noise due to discharge, whereas the receiving electrodes 8 sufficiently distant from the discharging scanning electrodes 31 are unaffected by the radiated noise due to discharge. In a state where the scanning electrodes 31 are selected one by one to discharge during the address discharge period, detecting the discharging scanning electrodes 31 and selecting the receiving electrodes 8 distant from such scanning electrodes 31 to receive response signals allow detection of a touch position free from (i.e., unaffected by) the radiated noise.

In the comparative example in FIG. 5B, in contrast, the transmitting electrodes 7 and the receiving electrodes 8 of the touch screen device 4 are disposed in the reverse directions to those in the present embodiment shown in FIG. 5A, and thus the receiving electrodes 8 of the touch screen device 4 are disposed orthogonal to the scanning electrodes 31 of the PDP 2. In this case, since the scanning electrodes 31 and the receiving electrodes 8 intersect, discharging from merely one scanning electrode 31 causes radiated noise on all receiving electrodes 8. It is thus difficult to detect a touch position without being affected by the radiated noise even during the address discharge period.

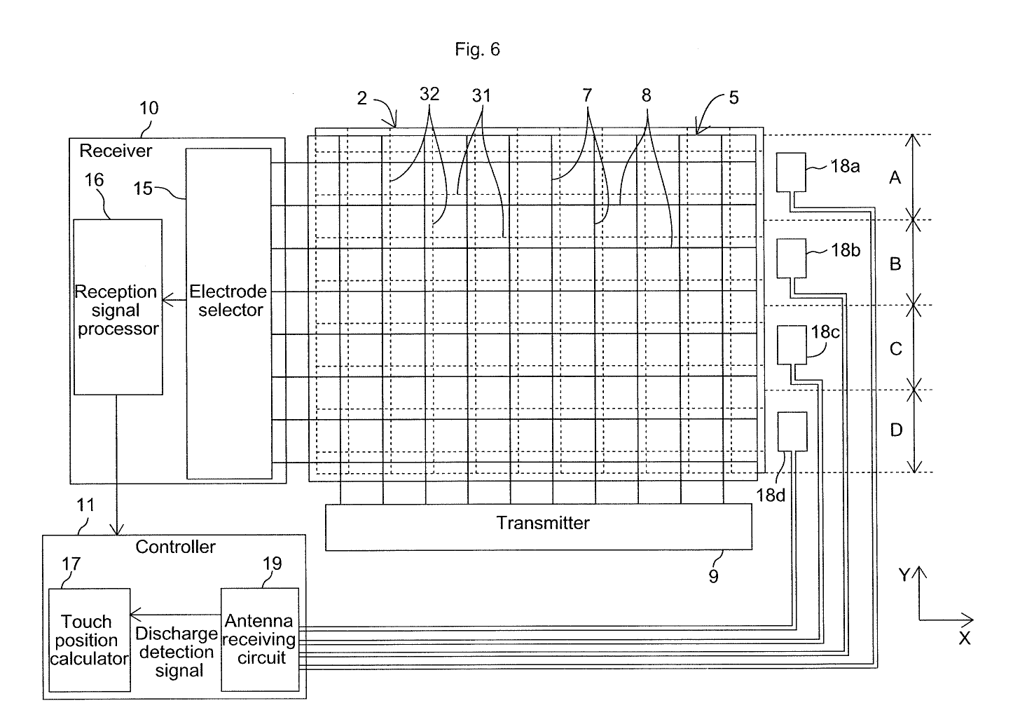

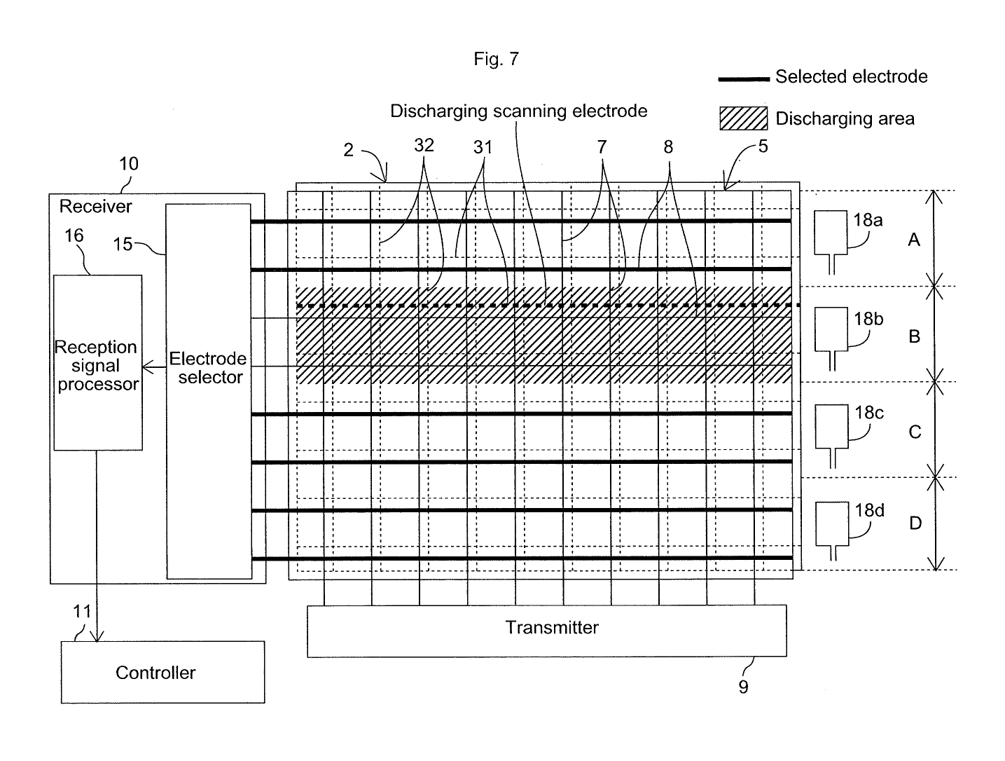

A configuration is explained below to allow scanning in the touch screen device 4 while preventing discharge of the PDP 2. FIG. 6 schematically illustrates a configuration of a main portion that detects the discharge of the PDP 2 in the touch screen device 4. FIG. 7 schematically illustrates a state of scanning during the address discharge period.

With reference to FIG. 6, the touch screen device 4 has a plurality of (four in the embodiment) antennas (discharge detectors) 18a to 18d detecting the radiated noise from the PDP 2. The controller 11 has an antenna receiving circuit (discharge detector) 19 detecting the discharge of the PDP 2 based on output signals from the antennas 18a to 18d.

The first through fourth antennas 18a to 18d are disposed adjacently in the Y direction in which the scanning electrodes 31 are arrayed. The antennas 18a to 18d detect the radiated noise associated with the discharge of the scanning electrodes 31 proximate to the antennas 18a to 18d. The antennas 18a to 18d may be each composed of a looped conductive wire mounted on a board. In order to enhance sensitivity, it is preferred that the antennas 18a to 18d have a resonant frequency proximate to the operating frequency of the PDP 2.

The antenna receiving circuit 19 processes analog signals output from the antennas 18a to 18d and outputs discharge detection signals that indicate occurrence of discharge. With the scanning electrodes 31 discharging proximate to the antennas 18a to 18d, the radiated noise detected by the antennas 18a to 18d becomes obvious. Whether or not the scanning electrodes 31 discharge proximate to the antennas 18a to 18d can thus be determined from comparison of appropriately processed output signals of the antennas 18a to 18d with a predetermined threshold.

Based on the detection results of the antenna receiving circuit 19, the controller 11 determines whether or not the scanning electrodes 31 are discharging, and then scans the receiving electrodes 8 distant from the scanning electrodes 31. Specifically, the receiving electrodes 8 distant from the discharging scanning electrodes 31 are selected so as to supply response signals from the receiving electrodes 8 to the reception signal processor 16.

In particular herein, the screen of the PDP 2 is divided into first to fourth discharge monitor areas A to D corresponding to the antennas 18a to 18d, respectively, along the Y direction in which the scanning electrodes 31 are disposed. The controller 11 determines whether or not the scanning electrodes 31 are discharging in each of the first to fourth discharge monitor areas A to D. Since the scanning electrodes 31 are selected one by one to discharge during the address discharge period, discharge is detected in only one of the first to fourth discharge monitor areas A to D. The receiving electrodes 8 are thus scanned in the remaining discharge monitor areas A to D where no discharge is detected.

In the example of FIG. 7, the scanning electrode 31 discharge in the second discharge monitor area B. The receiving electrodes 8 are scanned in the discharge monitor areas other than the second discharge monitor area B, which are the first discharge monitor area A, the third discharge monitor area C, and the fourth discharge monitor area D.

It is necessary to prevent the radiated noise due to discharge of the scanning electrodes 31 from affecting the receiving electrodes 8 positioned in the discharge monitor areas A to D adjacent to the discharge monitor areas A to D where the discharging scanning electrode 31 are positioned. To this end, the size of the first to fourth discharge monitor areas A to D is set in view of the impact range of the radiated noise due to discharge of the scanning electrodes 31. The number of antennas is set in accordance with the size of the discharge monitor areas A to D.

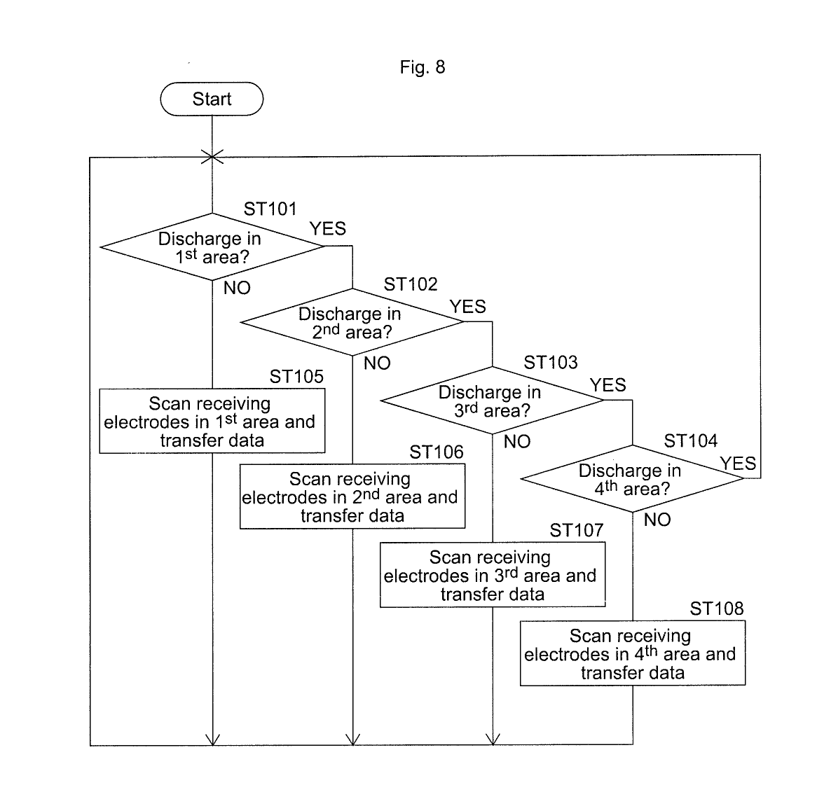

A procedure of scanning performed in the touch screen panel 4 is specifically explained below. FIG. 8 is a flowchart illustrating the procedure of processing performed in the controller 11 of the touch screen device 4.

Based on discharge detection signals output from the antenna receiving circuit 19, it is determined whether or not a discharge is occurring in each of the first to fourth discharge monitor areas A to D in sequence (ST101 to ST104). The discharge monitor areas A to D are scanned when no discharge is occurring. Specifically, the receiving electrodes 8 in the discharge monitor areas A to D where no discharge is occurring are sequentially selected; response signals output from the receiving electrodes 8 are supplied to the reception signal processer 16; and detection data is transferred from the reception signal processer 16 to the controller 11 (ST105 to ST108).

In these steps, it is determined whether or not the discharge is occurring in sequence starting from the first discharge monitor area A. If the discharge is occurring in the first discharge monitor area A, the receiving electrodes 8 in the second discharge monitor area B are sequentially selected, and then the receiving electrodes 8 in the third discharge monitor area C and the fourth discharge monitor area D are sequentially selected.

During the address discharge period, the scanning electrodes 31 are selected to discharge one by one. Thus, the discharge is determined based only on one of the first to fourth discharge monitor areas A to D, and the receiving electrodes 8 are scanned in the remaining discharge monitor areas A to D where no discharge is occurring. In contrast, during the initialization discharge and sustained discharge periods, all the scanning electrodes 31 discharge concurrently. It is thus determined that the discharge is occurring in all the first to fourth discharge monitor areas A to D and scanning is not performed.

In a case where the receiving electrodes 8 are selected to be scanned in the array order, such as, for example, from top to bottom of the screen, in the touch screen device 4, when the receiving electrodes 8 to be selected fall into the impact range of the radiated noise due to the discharge of the scanning electrode 31, the receiving electrodes 8 to be selected are suspended from being selected and put in a wait state for a wait time until they are out of the impact range of the radiated noise due to the discharge of the scanning electrode 31.

In the case of scanning each of the discharge monitor areas A to D in the procedure illustrated in FIG. 8, for instance, the second discharge monitor area B is scanned during discharge in the first discharge monitor area A. With the start of discharge in the second discharge monitor area B during scanning of the second discharge monitor area B, scanning is suspended in the second discharge monitor area B and put in a wait state for a wait time until the end of the discharge in the second discharge monitor area B.

Such a wait time generated during scanning extends the time to scan one frame (frame rate) and reduces detection speed of a touch position. At a low detection speed of a touch position, touch position detection cannot follow a touch operation with a pointing object, such as a finger. In a hand-writing mode, for example, in which a line is drawn according to a trajectory of a pointing object moved by a user, a defect may occur in which the line is disconnected, thus reducing usability.

To prevent a reduction in drawing performance attributed to the detection speed of a touch point, it is necessary to eliminate or shorten a wait time during scanning. A control example that improves this situation is explained below.

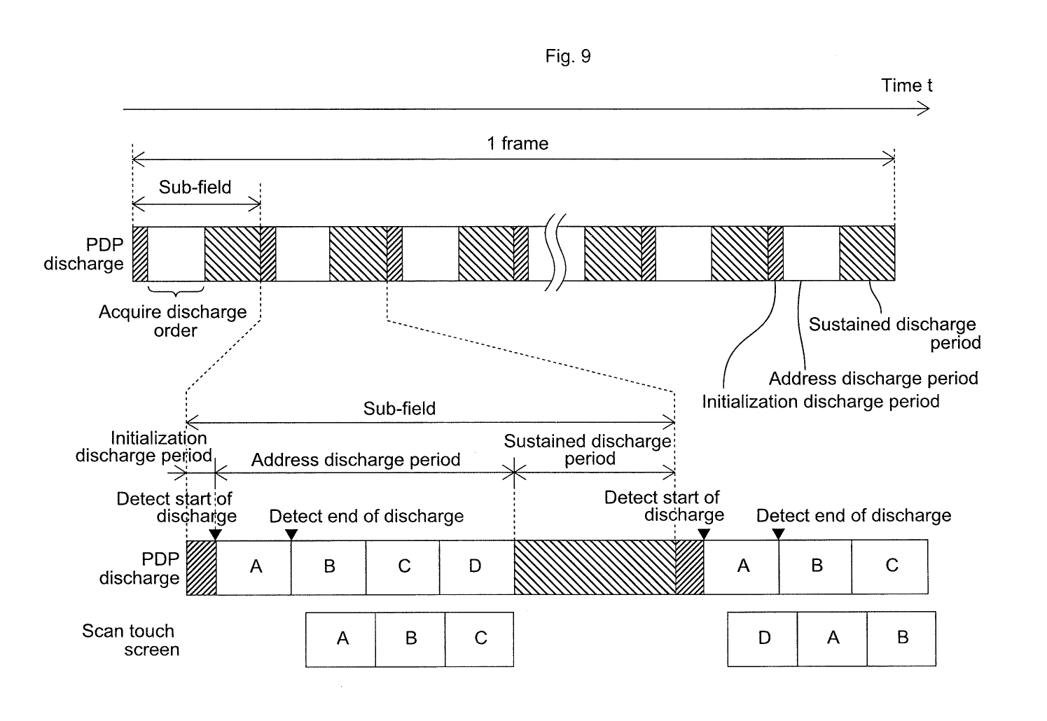

FIG. 9 schematically illustrates a state of discharge in the PDP 2 and scanning in the touch screen device 4. In the example, the discharge order during the address discharge is acquired in advance for the first to fourth discharge monitor areas A to D. The receiving electrodes 8 are scanned in the discharge monitor areas A to D where the discharge is not occurring in the discharge order. In the illustrated example, the scanning electrodes 31 discharge from top to bottom of the screen during the address discharge period and the discharge order of the discharge monitor areas A to D is A, B, C, and D.

In particular herein, the start and end of discharge are detected in the first discharge monitor area from A to D (A in the illustrated example) of the discharge order. Upon detecting the end of discharge in the first discharge monitor area from A to D, the discharge monitor areas A to D are sequentially scanned in the discharge order.

Thus, the discharge monitor areas A to D where the address discharge is completed are sequentially scanned, preventing the address discharge and scanning from being performed in the same discharge monitor areas A to D. In addition, time-efficient scanning eliminates or reduces a wait time during scanning, thus accelerating touch position detection.

The start of discharge in the discharge monitor areas A to D is the timing of discharge of the first scanning electrode 31 in the discharge monitor areas A to D. The end of discharge in the discharge monitor areas A to D is the timing of discharge of the last scanning electrode 31 in the discharge monitor areas A to D. The discharge can be determined based on the level of radiated noise indicated by output signals from the first to fourth antennas 18a to 18d.

In a case where the discharge order is possibly different by frame, the discharge order is checked for each frame. In this case, the discharge order is checked during the address discharge period of the first sub-field and scanning is performed during the address discharge period in the next and subsequent sub-fields, as shown in the drawing.

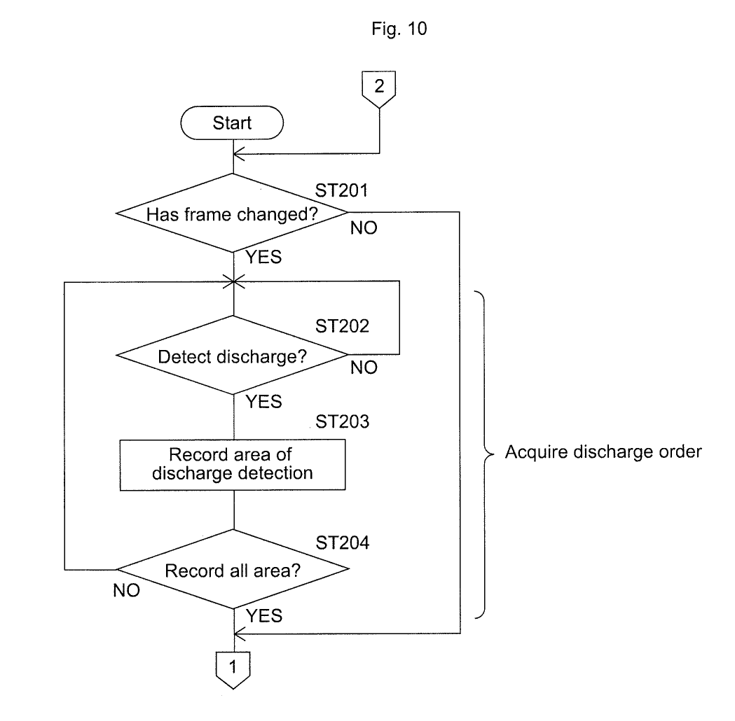

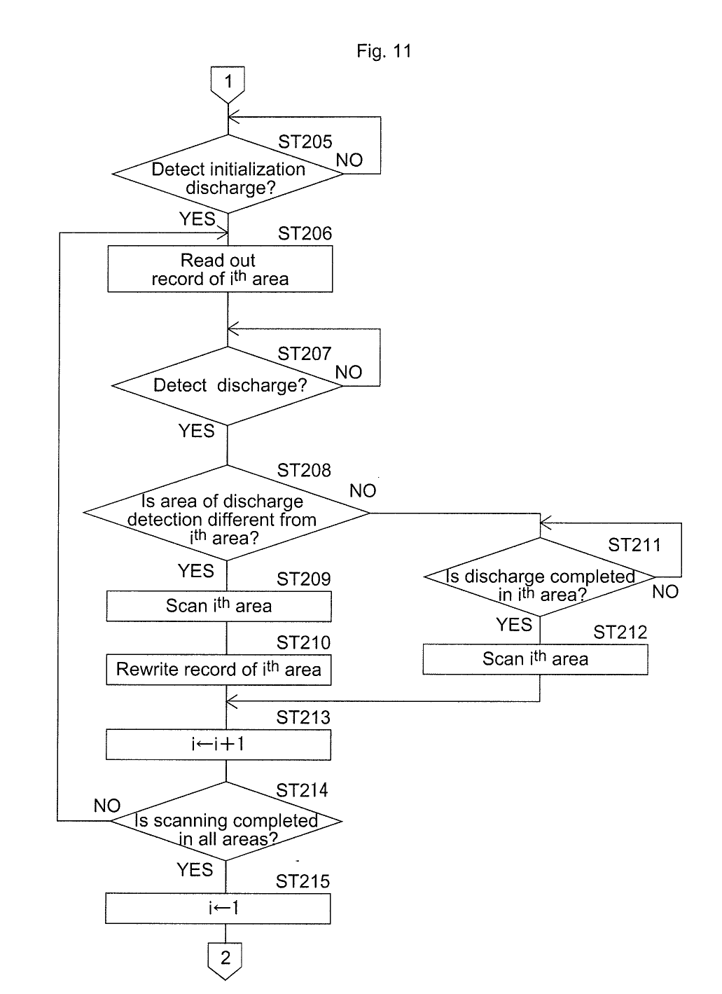

A procedure of scanning performed shown in FIG. 9 is specifically explained below. FIGS. 10 and 11 are each a flowchart illustrating processing performed in the controller 11 of the touch screen device 4.

With reference to FIG. 10, it is first determined whether or not a frame is new. When the frame is new (ST201: Yes), the discharge order is acquired. To acquire the discharge order, it is determined whether or not discharge is detected in any of the first to fourth discharge monitor areas A to D based on discharge detection signals output from the antenna receiving circuit 19 (ST202). When the discharge is detected, information of the discharge monitor areas A to D where the discharge is detected is stored in a memory (ST203).

With completion of storing the information of all the discharge monitor areas A to D (ST204: Yes), the process proceeds to scanning illustrated in FIG. 11. This processing allows the discharge order to be acquired of the discharge monitor areas A to D in accordance with the sequential discharge of the scanning electrodes 31 during the address discharge period.

When the frame is not new, specifically, when the next sub-field in the same frame is processed (ST201: No), the processing to acquire the discharge order is omitted, and scanning shown in FIG. 11 is performed based on the discharge order stored in the memory.

In the scanning, when it is determined to be in the address discharge period from detection of initialization discharge based on discharge detection signals output from the antenna receiving circuit 19 (ST205: Yes), the record of the i^{th} discharge monitor area in the discharge order is first read out (ST206). Then, when the discharge is detected in any of the first to fourth discharge monitor areas A to D (ST207: Yes), it is determined whether or not the discharge monitor area where the discharge is detected is different from the i^{th} discharge monitor area (ST208).

When the discharge monitor area where the discharge is detected is different from the i^{th} discharge monitor area (ST208: Yes), the receiving electrodes 8 in the i^{th} discharge monitor area are scanned. In this case, the recorded discharge order is different from the actual order, and the record of the i^{th} discharge monitor area is rewritten (ST210). When the discharge monitor area where the discharge is detected is identical to the i^{th}discharge monitor area (ST208: No), with completion of the discharge in the i^{th} discharge monitor area (ST211: Yes), the receiving electrodes 8 in the i^{th} discharge monitor area are scanned (ST212).

Then, the variable i, that indicates the discharge order, is incremented by one (ST213). When not all the first to fourth discharge monitor areas A to D are completed (ST214: No), the process proceeds to the discharge monitor areas A to D in the discharge order and repeats until all the discharge monitor areas A to D are completed. When all the discharge monitor areas A to D are completed (ST214: Yes), the variable i that indicates the discharge order is initialized (ST215), and then the process proceeds to the next frame.

The initialization discharge, the address discharge, and the sustained discharge can be differentiated based on the level of radiated noise detected by the antennas 18a to 18d, the time during which the radiated noise is continuously generated, and whether or not the radiated noise is detected in all the first to fourth discharge monitor areas A to D. Specifically, it is determined as the initialization discharge based on a high level of radiated noise in all the discharge monitor areas A to D and a short period of generation of the radiated noise; it is determined as the sustained discharge based on a high level of radiated noise in all the discharge monitor areas A to D and a long period of generation of the radiated noise; and it is determined as the address discharge based on a particularly high level of radiated noise in one of the discharge monitor areas A to D.

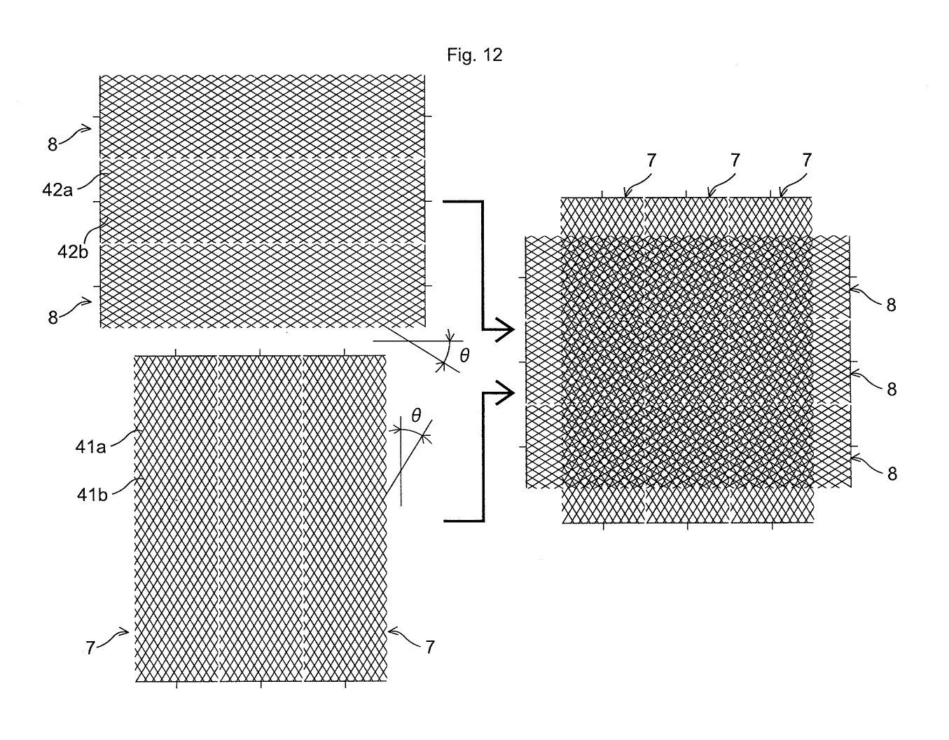

FIG. 12 is a plan view illustrating the transmitting electrodes 7 and the receiving electrodes 8. The transmitting electrodes 7 include mesh electrodes having conductive wires 41a and 41b disposed in a grid pattern. The conductive wires 41a extend obliquely at a predetermined angle θ clockwise relative to the longitudinal direction of the transmitting electrodes 7, while the conductive wires 41b extend obliquely at the predetermined angle θ counterclockwise relative to the longitudinal direction of the transmitting electrodes 7. An intersecting angle 20 of the conductive wires 41a and 41b is set to less than 90° to provide a continuous rhombic grid pattern. The conductive wires 41a and 41b are electrically connected at intersected portions.

Similar to the transmitting electrodes 7, the transmitting electrodes 8 include mesh electrodes having conductive wires 42a and 42b disposed in a grid pattern. The arrangement pattern of the conductive wires 42a and 42b is the same as that of the conductive wires 41a and 41b.

In such a configuration of the transmitting electrodes 7 and the receiving electrodes 8, the conductive wires 41a, 41b, 42a, and 42b are each formed with a fine line diameter, thus increasing invisibility of the transmitting electrodes 7 and the receiving electrodes 8 so as to enhance visibility of the screen of the PDP 2, that is disposed in the rear of the touch screen device 4. In addition, moire is prevented which is generated due to overlapping of the transmitting electrodes 7 and the receiving electrodes 8 on a pixel pattern of the PDP 2.

In the present embodiment, the antennas 18a to 18d are provided to detect the radiated noise of the PDP 2 as shown in FIG. 1. Alternatively, the receiving electrodes 8 may be configured to serve as antennas to detect the radiated noise. In this case, the discharge of the PDP 2 can be detected by processing output signals from the receiving electrodes 8 in a state where scanning is not performed.

In the present embodiment, the screen of the PDP 2 is divided into the four discharge monitor areas A to D. The present invention, however, is not limited to the embodiment. The screen may be divided appropriately in view of the impact range of the radiated noise due to the discharge of the scanning electrodes 31. Furthermore, the antennas 18a to 18d to detect the radiated noise of the PDP 2 are provided in the respective discharge monitor areas. The present invention, however, is not limited to the embodiment. A plurality of antennas may be associated with one discharge monitor area. Such a configuration is preferable in the case of using the receiving electrodes 8 as antennas, in particular.

In the present embodiment, whether or not the scanning electrodes 31 discharge is determined in each of the discharge monitor areas A to D and scanning is performed in units of the discharge monitor areas A to D. Instead, with numerous antennas provided or the receiving electrodes 8 serving as antennas, it is possible to determine whether or not the scanning electrodes 31 are discharging one by one.

In the present embodiment, the receiving electrodes 8 positioned distant from the scanning electrodes 31 that are discharging are scanned. In the present invention, detection accuracy of a touch position due to the radiated noise of the PDP 2 can be prevented from being reduced, provided at least that a touch position is acquired based on detection data at each of the electrode intersections using response signals of the receiving electrodes 8 positioned distant from the discharging scanning electrodes 31. For example, scanning may be performed regardless of which scanning electrodes 31 are discharging; detection data from the response signals of the receiving electrodes 8 positioned proximate to the discharging scanning electrodes 31 may be discarded; and scanning may be performed again to acquire data for the discarded detection data again.

In the present embodiment, the transmitting electrodes 7 and the receiving electrodes 8 are composed of mesh electrodes, as shown in FIG. 12. The transmitting electrodes and the receiving electrodes in the present invention are not limited to this embodiment. For example, conductive wires that serve as electrodes may be arrayed in one direction. Other than electrodes composed of opaque metal materials, transparent electrodes composed of, such as ITO, may also be employed.

In the present embodiment, the discharge of the scanning electrodes 31 is detected based on the radiated noise of the PDP 2. Alternatively, the PDP 2 may be configured to output signals that identify the discharging scanning electrodes 31 and, based on the signals, the touch screen device 2 may detect the discharge of the scanning electrodes 31. In this case, a signal generator/outputter should be provided in the PDP 2. In contrast, in the configuration where the discharge is detected based on the radiated noise of the PDP 2, it is unnecessary to add a special configuration in the PDP 2, implementation is easy, and an increase in manufacturing cost is not incurred.

In the present embodiment, the receiving electrodes 8 are selected one by one in the receiver 10. The embodiment, however, is not limited to the configuration where the receiving electrodes 8 are selected exclusively. For example, a configuration may be possible where the receiving electrodes 8 are divided into groups having a predetermined number of electrodes; a reception signal processer is provided in each of the groups; and the receiving electrodes 8 are selected one by one within each group, while the receiving electrodes 8 are selected from the groups in parallel. In this case, it is preferred that the receiving electrodes 8 be grouped in accordance with the discharge monitor areas.

The touch screen device and the plasma display apparatus having the same according to the present invention can prevent a reduction in detection accuracy of a touch position affected by radiated noise of a plasma display panel and can be effective as a touch screen device disposed in front of the plasma display panel or a plasma display apparatus having the same.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention. Further, features of the various alternate embodiments can be combined.

What is claimed is:

1. A touch screen device comprising:
a screen main body comprising a plurality of transmitting electrodes and a plurality of receiving electrodes and disposed in front of a plasma display panel, the transmitting electrodes being provided parallel to one another, the receiving electrodes being provided parallel to one another, the transmitting electrodes and the receiving electrodes being disposed in a grid shape, the receiving electrodes being disposed parallel to scanning electrodes of the plasma display panel;
a transmitter sequentially selecting the transmitting electrodes and applying a drive signal to the selected transmitting electrodes;
a receiver sequentially selecting the receiving electrodes, receiving a response signal output from each of the receiving electrodes in response to the drive signal, and outputting detection data at each electrode intersection;
a discharge detector detecting discharge of each of the scanning electrodes of the plasma display panel; and
a controller that obtains a touch position based on detection data of the discharge detector at each electrode intersection acquired from the response signals from the receiving electrodes positioned distant from the discharging scanning electrodes.

2. The touch screen device according to claim 1, wherein the plasma display panel is divided into a plurality of discharge monitor areas divided in an array direction of the scanning electrodes.

3. The touch screen device according to claim 2, wherein the discharge detector detects whether or not the scanning electrodes are discharging in each of the discharge monitor areas.

4. The touch screen device according to claim 3, wherein the controller obtains the touch position based on the detection data at each electrode intersection acquired from the response signals from the receiving electrodes positioned in the discharge monitor areas where no discharge is occurring.

5. The touch screen device according to claim 4, wherein the controller determines an order of address discharge in the plasma display panel in each of the discharge monitor areas, and, upon detecting completion of the address discharge in the first discharge monitor area in the order of address discharge, performs scanning by sequentially selecting the receiving electrodes in the discharge monitor areas in the order of address discharge.

6. The touch screen device according to claim 2, wherein the discharge detector comprises a plurality of antennas disposed adjacently in the array direction of the scanning electrodes.

7. The touch screen device according to claim 6, each of the antennas comprising a looped conductive wire mounted on a board and having a resonant frequency proximate an operating frequency of the plasma display panel.

8. The touch screen device according to claim 6, the discharge detector further comprising a circuit that processes signals output from the antennas and determines whether or not the scanning electrodes discharge proximate to the antennas based on a comparison of the processed output signals with a predetermined threshold.

9. The touch screen device according to claim 8, wherein the controller selects receiving electrodes distant from detected discharging scanning electrodes and scans the selected receiving electrodes.

10. The touch screen device according to claim 2, wherein a size of the plurality of discharge monitor areas is set based upon the impact range of the radiated noise resulting from discharge of the scanning electrodes.

11. The touch screen device according to claim 10, the discharge detector comprising a plurality of antennas arranged in the array direction of the scanning electrodes, a number of antennas being in accordance with a size of the discharge monitor areas.

12. A plasma display apparatus comprising the touch screen device according to claim 1 provided in front of a plasma display panel.
